(19) United States
(12) Patent Application Publication
(10) Pub. No.: US 2024/0020308 A1
(43) Pub. Date: Jan. 18, 2024

(54) LOCALLY-ADAPTIVE VECTOR QUANTIZATION FOR SIMILARITY SEARCH

(71) Applicant: Intel Corporation, Santa Clara, CA (US)

(72) Inventors: Maria Cecilia Aguerrebere Otegui, Sunnyvale, CA (US); Ishwar Bhati, Bangalore (IN); Mark Hildebrand, Portland, OR (US); Mariano Tepper, Portland, OR (US); Theodore Willke, Portland, OR (US)

(21) Appl. No.: 18/364,664

(22) Filed: Aug. 3, 2023

(51) Int. Cl. G06F 16/245; G06F 16/2453; G06F 16/2452

(52) U.S. Cl. CPC G06F 16/24569; G06F 16/2453; G06F 16/24526

(57) ABSTRACT

Systems, apparatuses and methods may provide for technology that conducts a traversal of a directed graph in response to a query, retrieves the plurality of vectors from a dynamic random access memory (DRAM) in accordance with the traversal of the directed graphs, wherein each vector in the plurality of vectors is compressed, decompresses the plurality of vectors, determines a similarity between the query and the decompressed plurality of vectors, and generates a response to the query based on the similarity between the query and the decompressed plurality of vectors.

### TECHNICAL FIELD

Embodiments generally relate to similarity searching in artificial intelligence (AI) applications. More particularly, embodiments relate to locally-adaptive vector quantization (LVQ) for similarity searching.

### BACKGROUND

Artificial intelligence (AI) applications may operate on data that is represented by high-dimensional vectors. Similarity searching in the AI context may involve identifying vectors that are close to one another according to a chosen similarity function, wherein the amount of data is relatively large (e.g., billions of vectors, each with hundreds of dimensions). Conventional solutions to conducting AI-based similarity searching may involve large memory footprints, low throughput and/or reduced accuracy.

### BRIEF DESCRIPTION OF THE DRAWINGS

The various advantages of the embodiments will become apparent to one skilled in the art by reading the following specification and appended claims, and by referencing the following drawings, in which:

FIG. 1 is a pseudo code listing of an example of a traversal of a directed graph according to an embodiment;

FIG. 2 is a set of plots of examples of vector value distributions according to embodiments;

FIG. 3A is a comparative plot of an example of conventional accuracy results versus compression ratio and enhanced accuracy results versus compression ratio according to an embodiment;

FIG. 3B is a comparative plot of an example of conventional accuracy results versus relatively small compression ratio and enhanced accuracy results versus relatively small compression ratio according to an embodiment;

FIG. 4 is a comparative plot of an example of conventional throughput results versus memory footprint and enhanced throughput results versus memory footprint according to an embodiment;

FIG. 5 is a comparative plot of an example of conventional throughput results versus accuracy and enhanced throughput results versus accuracy according to an embodiment;

FIG. 6 is a set of comparative plots of an example of conventional throughput results versus accuracy for global quantization and enhanced throughput results versus accuracy versus accuracy for locally-adaptive vector quantization according to an embodiment;

FIG. 7 is a flowchart of an example of a method of generating a directed graph according to an embodiment;

FIG. 8 is a flowchart of an example of a method of conducting a similarity search according to an embodiment;

FIG. 9 is a flowchart of an example of a method of adapting to data distribution shifts according to an embodiment;

FIG. 10 is a block diagram of an example of a performance-enhanced computing system according to an embodiment;

FIG. 11 is an illustration of an example of a semiconductor package apparatus according to an embodiment;

FIG. 12 is a block diagram of an example of a processor according to an embodiment; and

FIG. 13 is a block diagram of an example of a multi-processor based computing system according to an embodiment.

### DETAILED DESCRIPTION

In the deep learning era, high-dimensional vectors have become a common data representation for unstructured data (e.g., images, audio, video, text, genomics, and computer code). These representations are built such that semantically related items become vectors that are close to one another according to a chosen similarity function. Similarity searching is the process of retrieving items that are similar to a given query. The amount of unstructured data is constantly growing at an accelerated pace. For example, modern databases may include billions of vectors, each with hundreds of dimensions. Thus, creating faster and smaller indices to search these vector databases is advantageous for a wide range of applications, such as image generation, natural language processing (NLP), question answering, recommender systems, and advertisement matching.

The technology described herein performs a fast and accurate search in these large vector databases with a small memory footprint. More particularly, the Locally-adaptive Vector Quantization (LVQ) technology described herein reduces the memory footprint of the vector databases and, at the same time, improves search throughput (e.g., measured as Queries Per Second, QPS) at high accuracy by lowering the system memory bandwidth requirements.

The similarity search problem (also known as nearest-neighbor search) is defined as follows. Given a vector database X={xi∈R^{d}} i=1, . . . , n, containing n vectors with d dimensions each, a similarity function, and a query q∈R^{d}, seek the k vectors in X with maximum similarity to q. Given the size of modern databases, guaranteeing an exact retrieval becomes challenging and this definition is relaxed to allow for a certain degree of error (e.g., some retrieved elements may not be among the top k). This relaxation avoids performing a full linear scan of the database.

Graph-based methods, the predominant technique for in-memory similarity search at large scales, are fast and highly accurate at the cost of a large memory footprint. Hybrid solutions that combine system memory with solid-state drives provide a viable alternative when reduced throughput is acceptable. In the high-performance regime, however, there are no existing solutions that are simultaneously fast, highly accurate, and lightweight.

Graph-based similarity search: Graph-based similarity search works by building a navigable graph over a dataset and then conducting a modified best-first-search to find the approximate nearest neighbors of a query. In the following discussion, let G=(V, E) be a directed graph with vertices V corresponding to elements in a dataset X and edges E representing neighbor relationships between vectors. The set of out-neighbors of x in G is denoted with N(x). The similarity is computed with a similarity function sim: R^{d}×R^{d} [symbol] R^{d}, where a higher value indicates a higher degree of similarity.

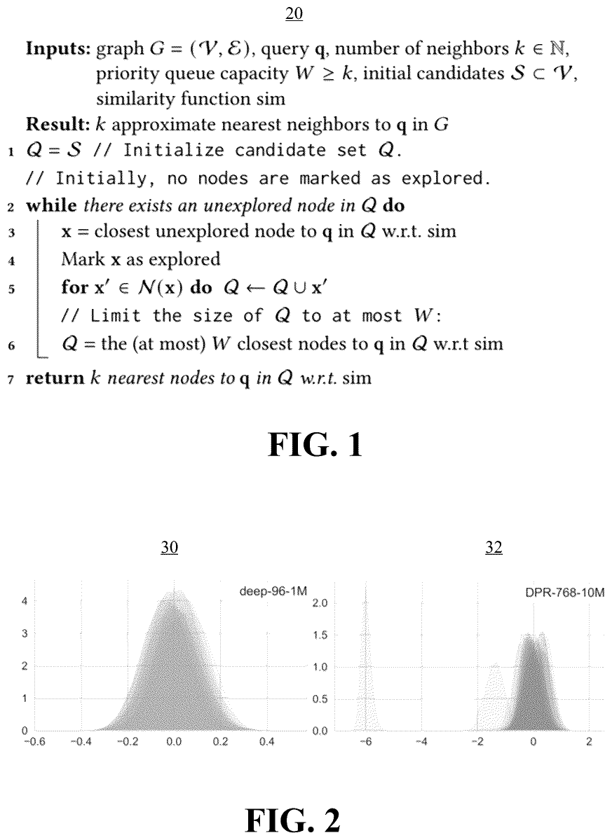

Turning now to FIG. 1, a pseudo code listing 20 demonstrates that a graph search involves retrieving the k nearest vectors to query q∈R^{d} with respect to the similarity function “sim” by using a modified “greedy” search over G. The parameter W provides a control knob to trade accuracy and performance as increasing W improves the accuracy of the k nearest neighbors at the cost of lower performance by exploring more of the graph.

Experiments and system setup: Search accuracy is measured by k-recall@k, defined by |S∩Gt|/k, where S are the identifiers of the k retrieved neighbors and Gt is the ground-truth. The value k=10 is used in all experiments. Search performance is measured by queries per second (QPS), with experiments being run on a host processor (e.g., central processing unit/CPU) with multiple cores (e.g., single socket), equipped with double data rate four (DDR4) memory. For comparison with the LVQ technology described herein, other prevalent similarity search procedures (e.g., “Vamana”, “HNSWLib”/Hierarchical Navigable Small World Library, “FAISS-IVFPQFS”, and an implementation of product quantization/PQ) are selected.

LVQ:

LVQ is an enhanced vector compression scheme that presents the following characteristics: (a) nimble decoding and similarity search computations, (b) compatibility with the random-access pattern present in graph-search, (c) a ˜4× compression, (d) ˜4× and ˜8× reductions in the effective bandwidth with respect to a float32-valued (32-bit floating point) vector, and (e) retention of high recall rates. These features significantly accelerate graph-base similarity search.

The IEEE 754 format (Institute of Electrical and Electronics Engineers/IEEE Standard for Binary Floating-Point Arithmetic, IEEE Std 754-1985) is designed for flexibility, allowing to represent a wide range of very small and very large numbers. Empirical analysis, however, of many standard datasets and deep learning embeddings indicate many regularities in the empirical distributions of their respective values. Embodiments leverage these regularities for quantization. The scalar quantization function is defined as:

$$Q ( x ; B , ℓ , u ) = Δ ⌊ \frac{x - ℓ}{Δ} + \frac{1}{2} ⌋ + ℓ , where Δ = \frac{u - ℓ}{{2}^{B} - 1} , \qquad ( 1 )$$

B is the number of bits used for the code, and the constants u and l are upper and lower bounds.

Definition 1. The Locally-adaptive Vector Quantization (LVQ-B) of vector x=[x₁, . . . , x_{d}] is defined with B bits as

[symbol]

(x)=[ [symbol] (x₁−μ₁;B, [symbol] ,u), . . . , [symbol] (x_{d}−μ_{d};B,l,u)], (2)

where the scalar quantization function Q is defined in Equation (1), μ=[μ₁, . . . , μ_{d}] is the mean of all vectors in X and the constants u and l are individually defined (e.g., on a per-vector basis) for each vector x=[x₁, . . . , x_{d}] by

$$\begin{matrix}u = {max}_{j} {x}_{j} - {μ}_{j} , & ℓ = {min}_{j} {x}_{j} - {μ}_{j} .\end{matrix} \qquad ( 3 )$$

FIG. 2 demonstrates in plots 30, 32 that working with mean-centered vectors in LVQ makes an efficient use of the dynamic range.

For each d-dimensional vector compressed with LVQ-B, the quantized values and the constants u and l are stored. The footprint in bytes of a vector compressed with LVQ-Bis:

footprint(Q(x))=(d·B+2B_{const})/8, (4)

where B_{const} is the number of bits used for u and for l. Typically, u and l are encoded in float16 (16-bit floating-point format), in which case B_{const}=16. Alternatively, global constants u and l could have been adopted (e.g., shared for all vectors), with a footprint of d·B/8 bytes. For high-dimensional datasets, where compression is more relevant, the LVQ overhead (e.g., 2B_{const}/8 bytes, typically 4 bytes), becomes negligible. This overhead is only 4% for the deep-96-1B dataset (d=96) and 0.5% for DPR-768-10M (d=768) when using 8 bits. LVQ provides improved search compared to this global quantization.

The compression ratio (CR) for LVQ is given by

CR(Q(x))=d·B_{orig}/(8·footprint(Q(x))), (5)

where B_{orig} is the number of bits per each dimension of x. Typically, vectors are encoded in float32, thus B_{orig}=32. For example, when using B=8 bits, the compression ratio for the deep-96-1B dataset (d=96) is 3.84 and 3.98 for the DPR-768-10M dataset (d=768).

Two-level quantization: In graph searching, most of the search time is spent (1) performing random dynamic random access memory (DRAM) accesses to retrieve the vectors associated with the out-neighbors of each node and (2) computing the similarity between the query and each vector. After optimizing the compute (e.g., using advanced vector extension/AVX instructions), this operation may be heavily dominated by the memory access time. This memory access time is exacerbated as the number d of dimensions increases (e.g., d is in the upper hundreds for deep learning embeddings).

To reduce the effective memory bandwidth during search, embodiments compress each vector in two levels, each with a fraction of the available bits (e.g., rather than full-precision vectors). After using LVQ for the first level, the residual vector r=x−μ−Q(x) is quantized. The scalar random variable Z=X−μ−Q(X), which models the first-level quantization error, follows a uniform distribution in (−Δ/2, Δ/2), see Equation (1). Thus, each component of r is encoded using the scalar quantization function

[symbol]

ᵣₑₛ(r;B′)=Q(x;B′,−ΔA/2,Δ/2), (6)

where B′ is the number of bits used for the residual code.

Definition 2. The two-level Locally-adaptive Vector Quantization (LVQ−B₁×B₂) of vector x as a pair of vectors Q(x), Qᵣₑₛ(r), such that
Q(x) is the vector x compressed with LVQ-B₁,
Qᵣₑₛ(r)=[Qᵣₑₛ(r₁; B₂), . . . , Qᵣₑₛ(r_{d}; B₂)],

where r=x−μ−Q(x) and Qᵣₑₛ is defined in Equation (6).

No additional constants are needed for the second-level, as they can be deduced from the first-level constants. Hence, LVQ-B1×B2 has the same memory footprint as LVQ-B with B=B1+B2.

The first level of compression is used during graph traversal, which improves the search performance by decreasing the effective bandwidth, determined by the number B1 of bits transmitted from memory for each vector. The reduced number of bits may generate a loss in accuracy. The second level, or compressed residuals, is used for a final re-ranking operation, recovering part of the accuracy lost in the first level. Here, Line 6 of the pseudo code listing 20 (FIG. 1) is replaced by a gather operation that fetches Qres(r) for each vector Q(x) in Q, recomputes the similarity between the query q and each Q(x)+Qres(r), and finally selects the top-k.

Adapting to shifts in the data distribution: In the case of dynamic indices (e.g., supporting insertions, deletions and updates), a compression approach that easily adapts to data distribution shifts is advantageous. Search accuracy can degrade significantly over time if the compression model and the index are not periodically updated. Rather than running expensive algorithms (e.g., executing multiple instances of k-means), the LVQ technology described herein provides a simpler model update. More particularly, a re-computation of the dataset mean μ and reencoding of the data vectors are conducted. These operations are simple, scale linearly with the size of the dataset, and do not require loading the full dataset in memory.

Accelerating LVQ with AVX: Vector instructions can be used to efficiently implement distance computations for LVQ-B and LVQ-B1×B2. Embodiments store compressed vectors as densely packed integers with scaling constants stored inline. When 8-bits are used, native AVX instructions are used to load and convert the individual components into floating-point values, which are combined with the scaling constants. The case of B1=B2=4 in LVQ-B1×B2 involves slightly more work, with vectorized integer shifts and masking being conducted. The decompression is fused with the distance computation against the query vector. This fusion, combined with loop unrolling and masked operations to tail elements, creates an efficient distance computation implementation that makes no function calls, decompresses the quantized vectors on-the-fly and accumulates partial results in AVX registers.

LVQ versus Product Quantization: Product quantization (PQ) is a popular compression technique for similarity search. PQ may often be used at high compression ratios and combined with re-ranking using full-precision vectors. PQ may also be used in this fashion for graphs stored in solid state drives (SSDs). When working with in-memory indices, there is a choice: either keep the full precision vectors and defeat compression altogether, or do not keep the full precision vectors and experience a severely degraded accuracy. This choice limits the usefulness of PQ for in-memory graph-based search.

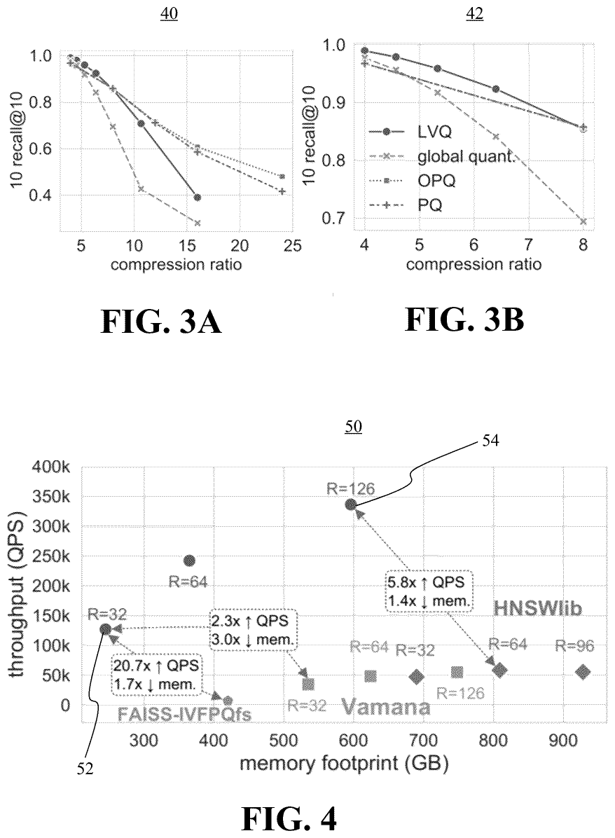

FIG. 3A shows a recall plot 40 of all compression ratios and FIG. 3B shows a recall plot 42 zoomed in on smaller compression ratios. The plots 40, 42 demonstrate the recall achieved by running an exhaustive search with vectors compressed using PQ, OPQ (optimized PQ, a PQ variant), LVQ and global quantization. PQ and OPQ perform better for smaller footprints. The achieved recall (below 0.7), however, is not acceptable in modern applications, requiring re-ranking. At higher footprints, where re-ranking can be avoided, LVQ achieves higher accuracy, while introducing almost no overhead for distance computations.

Additionally, PQ and its variants are more difficult to implement efficiently. For inverted indices, the similarity between partitions of the query and each corresponding centroid is generally precomputed to create a look-up table of partial similarities. The computation of the similarity between vectors essentially becomes a set of indexed gather and accumulate operations on this table, which are generally quite slow. This problem is exacerbated with an increased dataset dimensionality: the lookup table does not fit in level one (L1) cache, which slows down the gather operation. Optimized lookup operations may use AVX shuffle and blend instructions to compute the distance between a query and multiple dataset elements simultaneously, but this approach is not compatible with the random-access pattern characteristic of graph algorithms.

By contrast, LVQ achieves higher accuracy than both PQ and OPQ (e.g., PQ and OPQ curves overlap). LVQ provides the additional advantage of much faster similarity calculations. At higher compression ratios, re-ranking with full-precision vectors may be required for PQ and OPQ to reach a reasonable accuracy (e.g., defeating the purpose of compression).

Search with reduced memory footprint: In large-scale scenarios, the memory requirement for graph-based approaches grows quickly, making these solutions expensive (e.g., the system cost is dominated by the total DRAM price). For instance, for a dataset with 200 dimensional embeddings encoded in float32 and a graph with 128 neighbors per node, the memory footprint would be 122 gigabytes (GB) and 1.2 TB for 100 million and 1 billion vectors, respectively.

Combining a graph-based method with LVQ provides high search performance with a fraction of the memory. The term GS-LVQ is used herein to denote the combination of graph-based search and LVQ. Additionally, a graph can be built with LVQ-compressed vectors without impacting search accuracy, thus tackling another significant limitation of graph-based solutions.

FIG. 4 shows a plot 50 that demonstrates search throughput as a function of the memory footprint (e.g., measured as the maximum resident main memory usage while conducting the query search) of different solutions at a 0.9 10-recall@10 level of accuracy. In the case of the graph-based solutions (GS-LVQ, Vamana, HNSWlib), the memory footprint increases with the graph size given by the maximum number of outbound neighbors (R=32, 64, 126 are included for all methods). In the case of FAISS-IVFPQfs, the memory footprint remains almost constant for all combinations of the considered parameters.

More particularly, for graph-based methods, the memory footprint is a function of the graph out-degree R. With the low-memory configuration LVQ point 52 (R=32), the technology described herein outperforms Vamana, HNSWlib and FAISS-IVFPQfs, by 2.3×, 2.2× and 20.7× with 3.0×, 3.3× and 1.7× lower memory, respectively. With the highest-throughput configuration LVQ point 54 (R=126), the technology described herein outperforms the second-highest by 5.8× and uses 1.4× lower memory.

These results demonstrate that GS-LVQ can use a much smaller graph (R=32) and still outperform other solutions: by 2.3×, 2.2× and 20.7× in throughput with 3×, 3.3× and 1.7× less memory, with respect to Vamana, HNSWlib and FAISS-IVFPQfs, respectively.

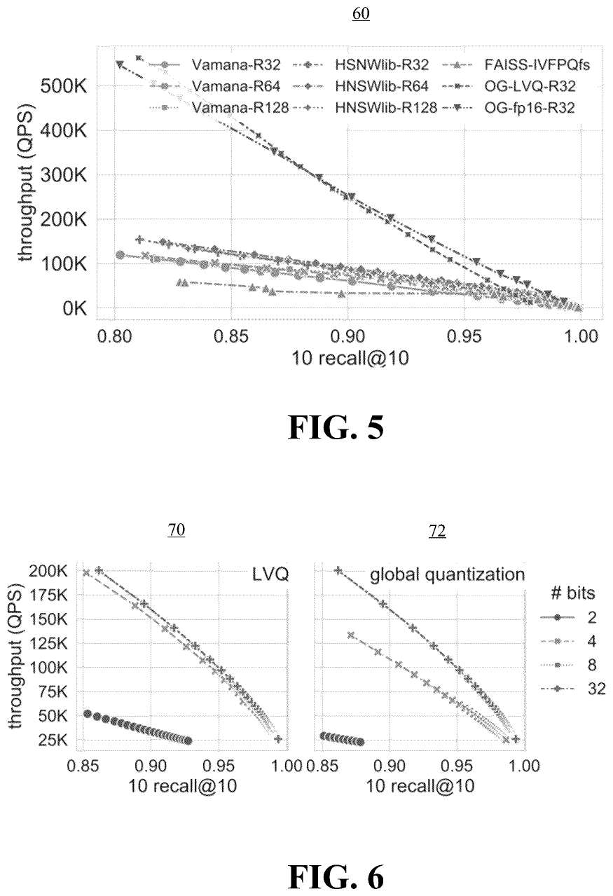

FIG. 5 shows a plot 60 demonstrating that OG-LVQ QPS/memory footprint superiority is consistent throughout recall values. The plot 60 shows the QPS vs. recall curves for the considered solutions working at different memory footprint points. That is, different R values for Vamana and HNSWlib, and a pareto line for FAISS-IVFPQfs built with all the considered parameter settings (e.g., because all have similar memory footprints). OG-LVQ, with a memory footprint of 23 GB (R=32), outperforms all competitors up to recall 0.98. In the extreme cases where a higher accuracy is advantageous, results using vectors encoded with float16 values outperforms the other solutions. This result may comes at the price, however, of an increased memory footprint with respect to the 23 GB of LVQ-8.

Graph Construction with LVQ-compressed vectors: FIG. 6 demonstrates that reducing the memory footprint during graph construction enables nimbler systems. For example, graph building may involve at least 835 GB for a maximum out degree R=128 for a dataset with 1-billion vectors. An LVQ plot 70 and a global quantization plot 72 demonstrate that when graphs are built with LVQ-compressed vectors, the search accuracy is almost unchanged even when setting B as low as 8 or 4 bits (e.g., the curves with 8 and 32 bits overlap). In contrast, a sharp drop in throughput is observed for graphs built using global quantization with 4 bits. The minimum memory requirements (e.g., graph+dataset size) in GB to construct a graph from full precision and from LVQ with B=4 bits are shown in Table I. Depending on the dataset and the graph maximum out-bound degree, the memory reduction can reach up to 6.2×.

TABLE I

| | deep-96-1B | | | text2Image-200-100M | | | DPR-768-10M | | |
|---|---|---|---|---|---|---|---|---|---|
| | Size (GB) | | | Size (GB) | | | Size (GB) | | |
| R | FP | LVQ-4 | Ratio | FP | LVQ-4 | Ratio | FP | LVQ-4 | Ratio |
| 32 | 477 | 168 | 2.84 | 864 | 216 | 4.00 | 298 | 48 | 6.20 |
| 64 | 596 | 287 | 2.08 | 983 | 335 | 2.93 | 310 | 60 | 5.17 |
| 128 | 834 | 525 | 1.59 | 1222 | 574 | 2.13 | 334 | 84 | 3.98 |

Accordingly, embodiments provide enhanced techniques to create faster and smaller indices for similarity search. A new vector compression solution, Locally-adaptive Vector Quantization (LVQ), simultaneously reduces memory footprint and improves search performance, with minimal impact on search accuracy. LVQ may work optimally in conjunction with graph-based indices, reducing the effective bandwidth while enabling random-access friendly fast similarity computations. LVQ, combined with graph-based indices, improves performance and reduces memory footprint, outcompeting the second-best alternatives for billion scale datasets: (1) in the low-memory regime, by up to 20.7× in throughput with up to a 3× memory footprint reduction, and (2) in the high-throughput regime by 5.8× with 1.4× lower memory requirements.

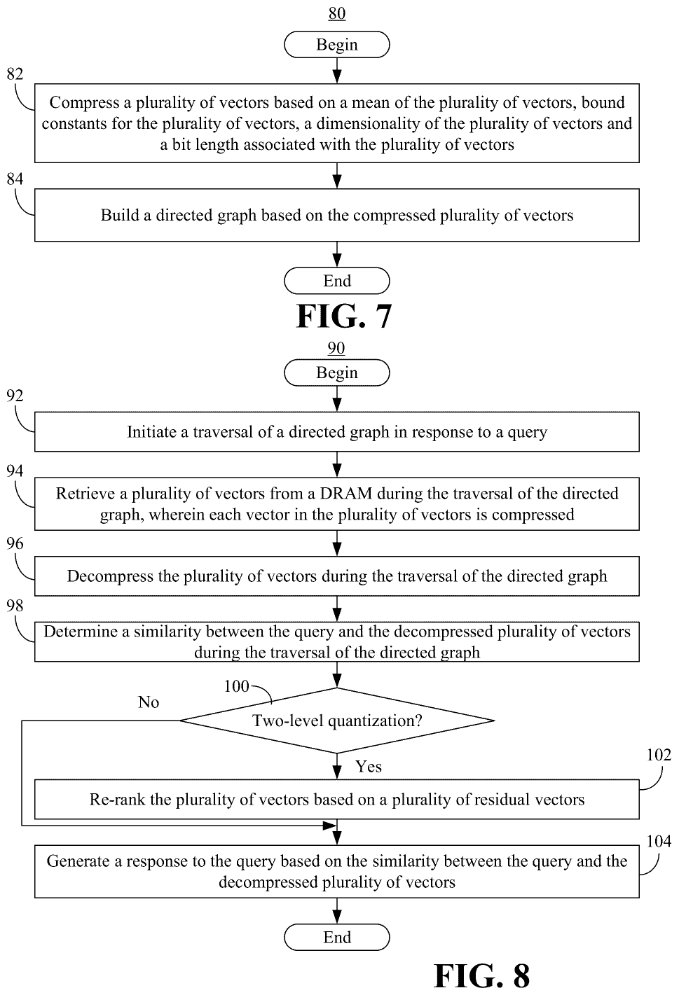

FIG. 7 shows a method 80 of generating a directed graph. The method 80 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 80 can be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 82 compresses a plurality of vectors based on a mean of the plurality of vectors, bound constants for the plurality of vectors, a dimensionality of the plurality of vectors and a bit length (e.g., number of bits) associated with the plurality of vectors. Block 84 builds a directed graph based on the compressed plurality of vectors. The method 80 therefore enhances performance at least to the extent that building the directed graph based on compressed vectors reduces the memory footprint and/or increases throughput (e.g., QPS).

FIG. 8 shows a method 90 of conducting a similarity search. The method 90 may generally be implemented in conjunction with the method 80 (FIG. 7), already discussed. More particularly, the method 90 may be implemented in one or more modules as a set of logic instructions stored in a machine- or computer-readable storage medium such a RAM, ROM, PROM, firmware, flash memory, etc., in hardware, or any combination thereof.

Illustrated processing block 92 initiate a traversal of a directed graph in response to a query, wherein block 94 retrieves a plurality of vectors from a DRAM during the traversal of the directed graph. In the illustrated example, each vector in the plurality of vectors is compressed. In an embodiment, block 94 retrieves the plurality of vectors from the DRAM via one or more advanced vector extension (AVX) instructions. Block 96 decompresses the plurality of vectors during the traversal of the directed graph. In one example, block 96 determines bound constants for the plurality of vectors on a per-vector basis (e.g., locally), wherein the plurality of vectors are decompressed based on the bound constants, a dimensionality of the plurality of vectors, and a bit length associated with the plurality of vectors. In such a case, the bound constants may include an upper bound constant and a lower bound constant. Block 98 determines a similarity between the query and the decompressed plurality of vectors during the traversal of the directed graph.

A determination is made at block 100 as to whether a two-level quantization is to be used. If so, block 102 re-ranks the plurality of vectors based on a plurality of residual vectors. Block 104 generates a response to the query based on the similarity between the query and the decompressed plurality of vectors. If the two-level quantization is used, block 104 generates the response further based on the re-ranked plurality of vectors. If a two-level quantization is not to be used, the illustrated method 90 bypasses block 102. The method 90 therefore enhances performance at least to the extent that retrieving locally-compressed vectors from DRAM in conjunction with a directed graph traversal increases the accuracy of similarity searches, particularly in the presence of relatively large datasets with high levels of dimensionality. Additionally, the use of AVX instructions and pre-fetching further enhances performance.

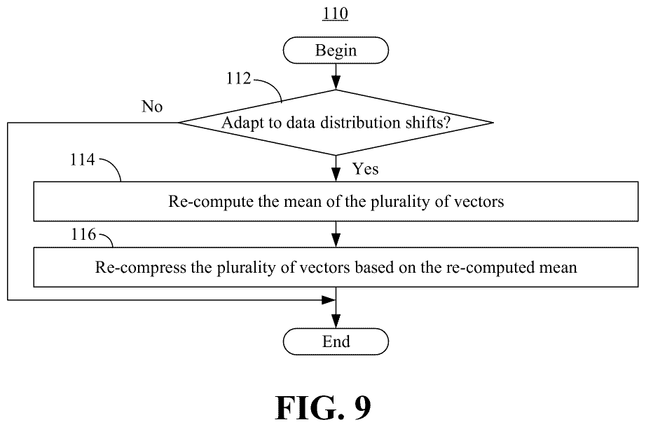

FIG. 9 shows a method 110 of adapting to data distribution shifts. The method 110 may generally be implemented in conjunction with the method 80 (FIG. 7) and/or the method 90 (FIG. 8), already discussed. More particularly, the method 110 may be implemented in one or more modules as a set of logic instructions stored in a machine- or computer-readable storage medium such a RAM, ROM, PROM, firmware, flash memory, etc., in hardware, or any combination thereof.

Illustrated processing block 112 determines whether adaptation to data distribution shifts is activated. If so, block 114 re-computes the mean of the plurality of vectors and block 116 re-compresses the plurality of vectors based on the re-computed mean. If it is determined that adaptation to data distribution shifts is not activated, the method 110 bypasses blocks 114 and 116, and terminates. The method 110 therefore further enhances performance at least to the extent that re-compressing the plurality of vectors prevents search accuracy from degrading over time. Additionally, re-compressing the plurality of vectors based on the re-computed mean further enhances performance by providing a simpler alternative to running multiple instances of k-means computations.

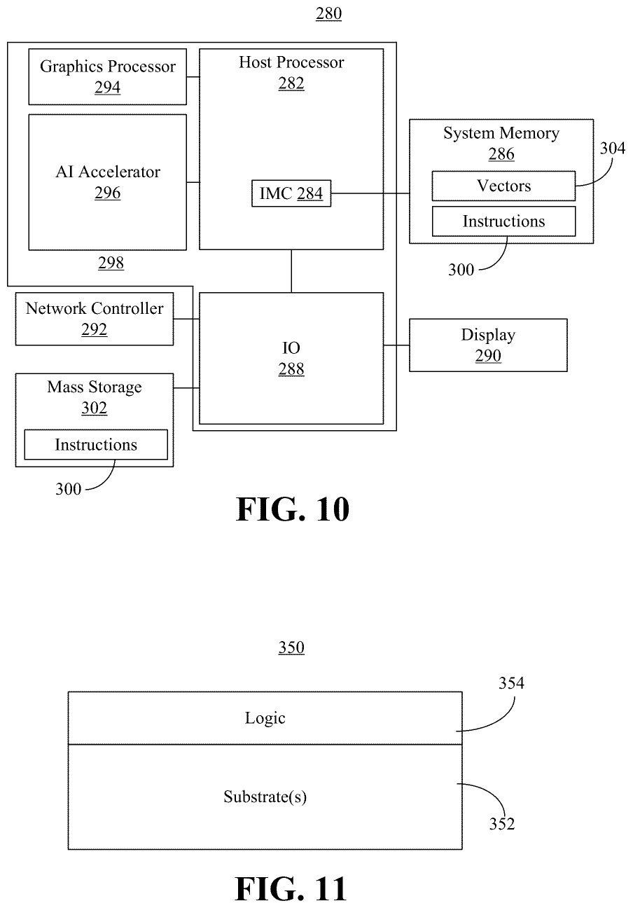

Turning now to FIG. 10, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including dynamic RAM/DRAM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298. In an embodiment, the system memory 286 stores a plurality of vectors 304 (e.g., representative of unstructured data such as images, audio, video, text, genomics, and/or computer code).

In an embodiment, the AI accelerator 296 and/or the host processor 282 execute instructions 300 retrieved from the system memory 286 and/or the mass storage 302 to perform one or more aspects of the method 80 (FIG. 7), the method 90 (FIG. 8) and/or the method 110 (FIG. 9), already discussed. Thus, execution of the instructions 300 causes the AI accelerator 296, the host processor 282 and/or the computing system 280 to conduct a traversal of a directed graph in response to a query and retrieve the plurality of vectors 304 from the system memory 286 in accordance with the traversal of the directed graphs, wherein the plurality of vectors 304 is compressed. Execution of the instructions 300 also causes the AI accelerator 296, the host processor 282 and/or the computing system 280 to decompress the plurality of vectors 304, determine a similarity between the query and the decompressed plurality of vectors 304 and generate a response to the query based on the similarity between the query and the decompressed plurality of vectors.

The computing system 280 is therefore considered performance-enhanced at least to the extent that retrieving locally-compressed vectors from the system memory 286 in conjunction with a directed graph traversal increases the accuracy of similarity searches, particularly in the presence of relatively large datasets with high levels of dimensionality. Additionally, the use of AVX instructions and pre-fetching further enhance performance.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 80 (FIG. 7), the method 90 (FIG. 8) and/or the method 110 (FIG. 9), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

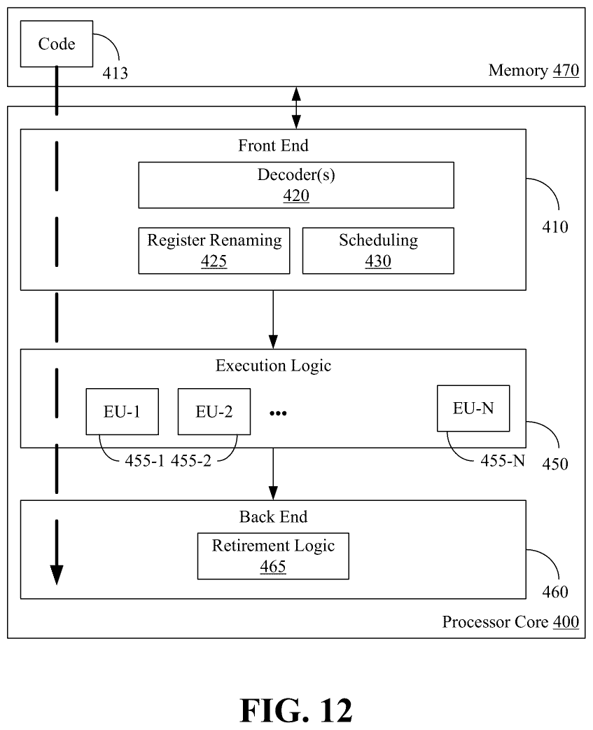

FIG. 12 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 12, a processing element may alternatively include more than one of the processor core 400 illustrated in FIG. 12. The processor core 400 may be a single-threaded core or, for at least one embodiment, the processor core 400 may be multithreaded in that it may include more than one hardware thread context (or “logical processor”) per core.

FIG. 12 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 80 (FIG. 7), the method 90 (FIG. 8) and/or the method 110 (FIG. 9), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 12, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

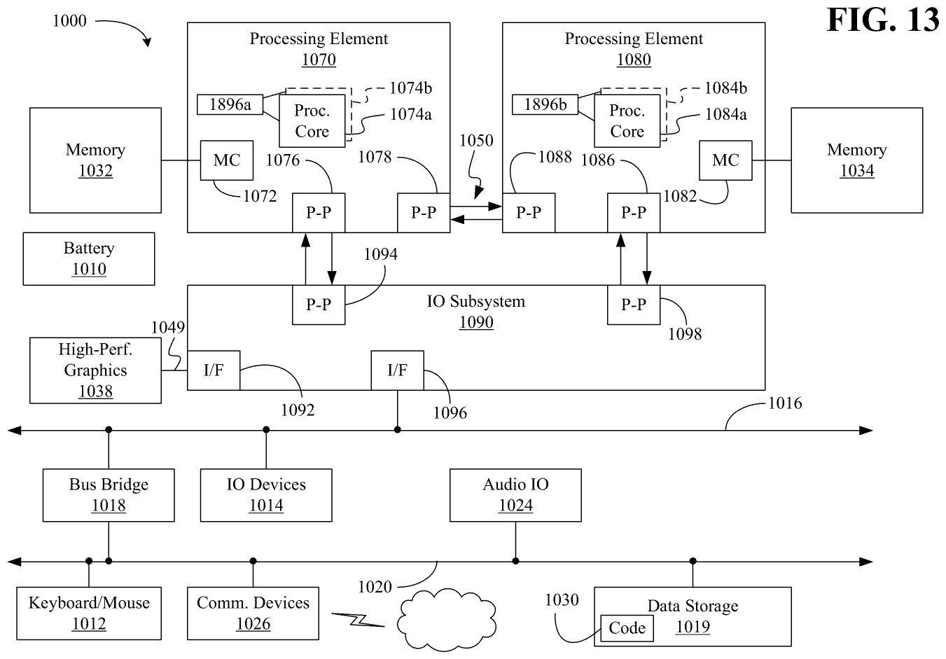

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 80 (FIG. 7), the method 90 (FIG. 8) and/or the method 110 (FIG. 9), already discussed. Further, an audio I/O 1024 may be coupled to second bus 1020 and a battery 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

### Additional Notes and Examples

Example 1 includes a performance-enhanced computing system comprising a network controller, a processor coupled to the network controller, and a dynamic random access memory (DRAM) coupled to the processor, wherein the DRAM is to store a plurality of vectors and a set of instructions, which when executed by the processor, cause the processor to initiate a traversal of a directed graph in response to a query, retrieve the plurality of vectors from the DRAM during the traversal of the directed graph, wherein each vector in the plurality of vectors is compressed, decompress the plurality of vectors during the traversal of the directed graph, determine a similarity between the query and the decompressed plurality of vectors during the traversal of the directed graph, and generate a response to the query based on the similarity between the query and the decompressed plurality of vectors.

Example 2 includes the computing system of Example 1, wherein the instructions, when executed, further cause the processor to determine bound constants for the plurality of vectors on a per-vector basis, and wherein the plurality of vectors are decompressed based on the bound constants, a dimensionality of the plurality of vectors, and a bit length associated with the plurality of vectors.

Example 3 includes the computing system of Example 2, wherein the bound constants are to include an upper bound constant and a lower bound constant.

Example 4 includes the computing system of any one of Examples 2 to 3, wherein the instructions, when executed, further cause the processor to compress the plurality of vectors based on a mean of the plurality of vectors, the bound constants, the dimensionality of the plurality of vectors, and the bit length associated with the plurality of vectors, and build the directed graph based on the compressed plurality of vectors.

Example 5 includes the computing system of Example 4, wherein the instructions, when executed, further cause the processor to re-compute the mean of the plurality of vectors, and re-compress the plurality of vectors based on the re-computed mean of the plurality of vectors.

Example 6 includes at least one computer readable storage medium comprising a set of instructions, which when executed by a computing system, cause the computing system to initiate a traversal of a directed graph in response to a query, retrieve a plurality of vectors from a dynamic random access memory (DRAM) during the traversal of the directed graph, wherein each vector in the plurality of vectors is compressed, decompress the plurality of vectors during the traversal of the directed graph, determine a similarity between the query and the decompressed plurality of vectors during the traversal of the directed graph, and generate a response to the query based on the similarity between the query and the decompressed plurality of vectors.

Example 7 includes the at least one computer readable storage medium of Example 6, wherein the instructions, when executed, further cause the computing system to determine bound constants for the plurality of vectors on a per-vector basis, and wherein the plurality of vectors are decompressed based on the bound constants, a dimensionality of the plurality of vectors, and a bit length associated with the plurality of vectors.

Example 8 includes the at least one computer readable storage medium of Example 7, wherein the bound constants are to include an upper bound constant and a lower bound constant.

Example 9 includes the at least one computer readable storage medium of Example 7, wherein the instructions, when executed, further cause the computing system to compress the plurality of vectors based on a mean of the plurality of vectors, the bound constants, the dimensionality of the plurality of vectors, and the bit length associated with the plurality of vectors, and build the directed graph based on the compressed plurality of vectors.

Example 10 includes the at least one computer readable storage medium of Example 9, wherein the instructions, when executed, further cause the computing system to re-compute the mean of the plurality of vectors, and re-compress the plurality of vectors based on the re-computed mean of the plurality of vectors.

Example 11 includes the at least one computer readable storage medium of any one of Examples 6 to 10, wherein the plurality of vectors are retrieved from the DRAM via one or more advanced vector extension instructions.

Example 12 includes the at least one computer readable storage medium of any one of Examples 6 to 11, wherein the instructions, when executed, further cause the computing system to re-rank the plurality of vectors based on a plurality of residual vectors, and wherein the response is further generated based on the re-ranked plurality of vectors.

Example 13 includes a semiconductor apparatus comprising one or more substrates, and circuitry coupled to the one or more substrates, wherein the circuitry is implemented at least partly in one or more of configurable or fixed-functionality hardware, the circuitry to initiate a traversal of a directed graph in response to a query, retrieve a plurality of vectors from a dynamic random access memory (DRAM) during the traversal of the directed graph, wherein each vector in the plurality of vectors is compressed, decompress the plurality of vectors during the traversal of the directed graph, determine a similarity between the query and the decompressed plurality of vectors during the traversal of the directed graph, and generate a response to the query based on the similarity between the query and the decompressed plurality of vectors.

Example 14 includes the semiconductor apparatus of Example 13, wherein the circuitry is to determine bound constants for the plurality of vectors on a per-vector basis, and wherein the plurality of vectors are decompressed based on the bound constants, a dimensionality of the plurality of vectors, and a bit length associated with the plurality of vectors.

Example 15 includes the semiconductor apparatus of Example 14, wherein the bound constants are to include an upper bound constant and a lower bound constant.

Example 16 includes the semiconductor apparatus of Example 14, wherein the circuitry is further to compress the plurality of vectors based on a mean of the plurality of vectors, the bound constants, the dimensionality of the plurality of vectors, and the bit length associated with the plurality of vectors, and build the directed graph based on the compressed plurality of vectors.

Example 17 includes the semiconductor apparatus of Example 16, wherein the circuitry is further to re-compute the mean of the plurality of vectors, and re-compress the plurality of vectors based on the re-computed mean of the plurality of vectors.

Example 18 includes the semiconductor apparatus of any one of Examples 13 to 17, wherein the plurality of vectors are retrieved from the DRAM via one or more advanced vector extension instructions.

Example 19 includes the semiconductor apparatus of any one of Examples 13 to 18, wherein the circuitry is further to re-rank the plurality of vectors based on a plurality of residual vectors, and wherein the response is further generated based on the re-ranked plurality of vectors.

Example 20 includes the semiconductor apparatus of any one of Examples 13 to 18, wherein the circuitry coupled to the one or more substrates includes transistor channel regions that are positioned within the one or more substrates.

Example 21 includes a method of operating a performance-enhanced computing system, the method comprising initiating a traversal of a directed graph in response to a query, retrieving a plurality of vectors from a dynamic random access memory (DRAM) during the traversal of the directed graph, wherein each vector in the plurality of vectors is compressed, decompressing the plurality of vectors during the traversal of the directed graph, determining a similarity between the query and the decompressed plurality of vectors during the traversal of the directed graph, and generating a response to the query based on the similarity between the query and the decompressed plurality of vectors.

Example 22 includes an apparatus comprising means for performing the method of Example 21.

The technology described herein therefore reduces the memory footprint of vector databases and, at the same time, improves graph-based similarity search performance without sacrificing accuracy. A vector compression scheme, Locally-adaptive Vector Quantization (LVQ), supports many standard datasets and deep learning embeddings and leverages the regularities in the empirical distributions of their values. LVQ provides a) nimble decoding and similarity search computations even with random access patterns common in graph-based search procedures, (b) a ˜4× compression, (c) ˜4× and ˜8× reductions in the effective memory bandwidth, with respect to a float32-valued vector, and (d) high recall rates.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a dynamic random access memory (DRAM) coupled to the processor, wherein the DRAM is to store a plurality of vectors and a set of instructions, which when executed by the processor cause the processor to:
initiate a traversal of a directed graph in response to a query,
retrieve the plurality of vectors from the DRAM during the traversal of the directed graph, wherein each vector in the plurality of vectors is compressed,
decompress the plurality of vectors during the traversal of the directed graph,
determine a similarity between the query and the decompressed plurality of vectors during the traversal of the directed graph, and
generate a response to the query based on the similarity between the query and the decompressed plurality of vectors.

2. The computing system of claim 1, wherein the instructions, when executed, further cause the processor to determine bound constants for the plurality of vectors on a per-vector basis, and wherein the plurality of vectors are decompressed based on the bound constants, a dimensionality of the plurality of vectors, and a bit length associated with the plurality of vectors.

3. The computing system of claim 2, wherein the bound constants are to include an upper bound constant and a lower bound constant.

4. The computing system of claim 2, wherein the instructions, when executed, further cause the processor to:
compress the plurality of vectors based on a mean of the plurality of vectors, the bound constants, the dimensionality of the plurality of vectors, and the bit length associated with the plurality of vectors, and
build the directed graph based on the compressed plurality of vectors.

5. The computing system of claim 4, wherein the instructions, when executed, further cause the processor to:
re-compute the mean of the plurality of vectors, and
re-compress the plurality of vectors based on the re-computed mean of the plurality of vectors.

6. At least one computer readable storage medium comprising a set of instructions, which when executed by a computing system, cause the computing system to:
initiate a traversal of a directed graph in response to a query;
retrieve a plurality of vectors from a dynamic random access memory (DRAM) during the traversal of the directed graph, wherein each vector in the plurality of vectors is compressed;
decompress the plurality of vectors during the traversal of the directed graph;
determine a similarity between the query and the decompressed plurality of vectors during the traversal of the directed graph; and
generate a response to the query based on the similarity between the query and the decompressed plurality of vectors.

7. The at least one computer readable storage medium of claim 6, wherein the instructions, when executed, further cause the computing system to determine bound constants for the plurality of vectors on a per-vector basis, and wherein the plurality of vectors are decompressed based on the bound constants, a dimensionality of the plurality of vectors, and a bit length associated with the plurality of vectors.

8. The at least one computer readable storage medium of claim 7, wherein the bound constants are to include an upper bound constant and a lower bound constant.

9. The at least one computer readable storage medium of claim 7, wherein the instructions, when executed, further cause the computing system to:
compress the plurality of vectors based on a mean of the plurality of vectors, the bound constants, the dimensionality of the plurality of vectors, and the bit length associated with the plurality of vectors; and
build the directed graph based on the compressed plurality of vectors.

10. The at least one computer readable storage medium of claim 9, wherein the instructions, when executed, further cause the computing system to:
re-compute the mean of the plurality of vectors; and
re-compress the plurality of vectors based on the re-computed mean of the plurality of vectors.

11. The at least one computer readable storage medium of claim 6, wherein the plurality of vectors are retrieved from the DRAM via one or more advanced vector extension instructions.

12. The at least one computer readable storage medium of claim 6, wherein the instructions, when executed, further cause the computing system to re-rank the plurality of vectors based on a plurality of residual vectors, and wherein the response is further generated based on the re-ranked plurality of vectors.

13. A semiconductor apparatus comprising:
one or more substrates; and
circuitry coupled to the one or more substrates, wherein the circuitry is implemented at least partly in one or more of configurable or fixed-functionality hardware, the circuitry to:
initiate a traversal of a directed graph in response to a query;
retrieve a plurality of vectors from a dynamic random access memory (DRAM) during the traversal of the directed graph, wherein each vector in the plurality of vectors is compressed;
decompress the plurality of vectors during the traversal of the directed graph;
determine a similarity between the query and the decompressed plurality of vectors during the traversal of the directed graph; and
generate a response to the query based on the similarity between the query and the decompressed plurality of vectors.

14. The semiconductor apparatus of claim 13, wherein the circuitry is to determine bound constants for the plurality of vectors on a per-vector basis, and wherein the plurality of vectors are decompressed based on the bound constants, a dimensionality of the plurality of vectors, and a bit length associated with the plurality of vectors.

15. The semiconductor apparatus of claim 14, wherein the bound constants are to include an upper bound constant and a lower bound constant.

16. The semiconductor apparatus of claim 14, wherein the circuitry is further to:
compress the plurality of vectors based on a mean of the plurality of vectors, the bound constants, the dimensionality of the plurality of vectors, and the bit length associated with the plurality of vectors; and
build the directed graph based on the compressed plurality of vectors.

17. The semiconductor apparatus of claim 16, wherein the circuitry is further to:
re-compute the mean of the plurality of vectors; and
re-compress the plurality of vectors based on the re-computed mean of the plurality of vectors.

18. The semiconductor apparatus of claim 13, wherein the plurality of vectors are retrieved from the DRAM via one or more advanced vector extension instructions.

19. The semiconductor apparatus of claim 13, wherein the circuitry is further to re-rank the plurality of vectors based on a plurality of residual vectors, and wherein the response is further generated based on the re-ranked plurality of vectors.

20. The semiconductor apparatus of claim 13, wherein the circuitry coupled to the one or more substrates includes transistor channel regions that are positioned within the one or more substrates.
